(19) United States
(12) Patent Application Publication
(10) Pub. No.: US 2026/0073925 A1
(43) Pub. Date: Mar. 12, 2026

(54) VOICE IDENTIFICATION VIA RADIO WAVE DEMODULATION

(71) Applicant: Infinitus Holdings Inc., Penn Valley, PA (US)

(72) Inventors: Joshua Ian Cohen, Penn Valley, PA (US); John Cronin, Jericho, VT (US)

(21) Appl. No.: 18/827,531

(22) Filed: Sep. 6, 2024

(51) Int. Cl. G10L 17/06

(52) U.S. Cl. CPC G10L 17/06

(57) ABSTRACT

A system includes a phased antenna array configured to receive signals from at least one signal source not initially designed to provide a signal related to sound. The system also includes a signal processor configured to locate the at least one signal source using the received signals and detect a movement of the at least one signal source relative to the phased antenna array, wherein the detected movement is at least partially in response to sound waves impinging on the at least one signal source. The system further includes a sound demodulator configured to demodulate the sound waves from the detected movement.

### FIELD OF THE DISCLOSURE

The present disclosure is generally related to systems and methods for voice identification via radio wave demodulation.

### BACKGROUND

Traditional audio surveillance methods can be easily detected and obstructed, reducing their effectiveness in sensitive operations where maintaining secrecy and avoiding interference is crucial. Recording audio at a distance, without first placing a listening device, is difficult or impossible without direct line of sight or extremely high power sound amplification. Further, audio surveillance methods typically require precision tools. It is difficult to extract audio information from a large area without placing a multitude of listening devices throughout the area. This can be costly and/or impractical.

### SUMMARY

Disclosed herein are systems and methods that overcome the aforementioned problems and disadvantages. According to one aspect, a system includes a phased antenna array configured to receive signals from at least one signal source not initially designed to provide a signal related to sound. The system also includes a signal processor configured to locate the at least one signal source using the received signals and detect a movement of the at least one signal source relative to the phased antenna array wherein the detected movement is at least partially in response to sound waves impinging on the at least one signal source. The system further includes a sound demodulator configured to demodulate the sound waves from the detected movement.

In some embodiments, the at least one signal source includes one or more of a vibration detector, a passive tag, and/or a user device.

In some embodiments, the vibration detector actively transmits the signals to the phased antenna array without being pinged by the phased antenna array.

In some embodiments, the passive tag transmits the signals to the phased antenna array in response to being pinged by the phased antenna array.

In some embodiments, the passive tag is a radio frequency identification (RFID) tag.

In some embodiments, the signal processor is configured to locate the at least one signal source using one or more of Kalman filtering, a joint probabilistic data association (JPDA) operation, and/or a Multiple Signal Classification (MUSIC) algorithm.

In some embodiments, the signal processor is configured to triangulate a location of the at least one signal source using an angle of arrival (AoA) calculation based on a difference in phase and time of the received signals arriving at the phased antenna array.

In some embodiments, the signal processor is configured to determine a location of the at least one signal source using trilateration.

In some embodiments, the signal processor is further configured to identify signal components of the signals from the at least one signal source.

In some embodiments, the sound demodulator is configured to filter identified components of the received signals to produce a filtered signal.

In some embodiments, the sound demodulator is configured to process the filtered signal to isolate a sound signal from noise in the filtered signal.

In some embodiments, the sound demodulator is configured to process the filtered signal by one or more of independent component analysis, fast Fourier transform, low-pass filtering, and/or digital signal processing.

In some embodiments, the sound demodulator is configured to apply a sound recognition algorithm to identify a sound signal in the received signals.

In some embodiments, the sound recognition algorithm uses machine learning to identify a particular sound in the sound signal.

In some embodiments, the sound demodulator is configured to generate a voice print from the sound signal if the sound signal contains a voice.

In some embodiments, the voice print is identified based on features including Mel-Frequency Cepstral Coefficients (MFCCs), Linear Predictive Coding (LPC) coefficients, and/or formant frequencies.

In some embodiments, the sound demodulator is further configured to amplify the sound signal to an audible intensity.

In some embodiments, the system further includes a sound output device to play the amplified sound signal.

According to another aspect, a method includes receiving, via a phased antenna array, signals from at least one signal source. The method also includes locating, via signal processor, the at least one signal source using the received signals. The method further includes detecting, via the signal processor, a movement of the at least one signal source relative to the phased antenna array, wherein the detected movement is at least partially in response to sound waves impinging on the at least one signal source. In addition, the method includes demodulating the sound waves from the detected movement to produce a sound signal.

In some embodiments, the method further includes playing the sound signal on an output device.

### BRIEF DESCRIPTION OF THE DRAWINGS

FIG. 1 is a schematic diagram of a phased array tracking system according to an embodiment.

FIG. 2 is a flowchart of a method performed by a Base Module according to an embodiment.

FIG. 3 is a flowchart of a method performed by a Signal Processing Module according to an embodiment.

FIG. 4 is a flowchart of a method performed by a Sound Demodulation Module according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be provided in many different forms and should not be construed as limited to the embodiments set forth herein. The examples set forth herein are non-limiting examples and are merely examples among other possible examples.

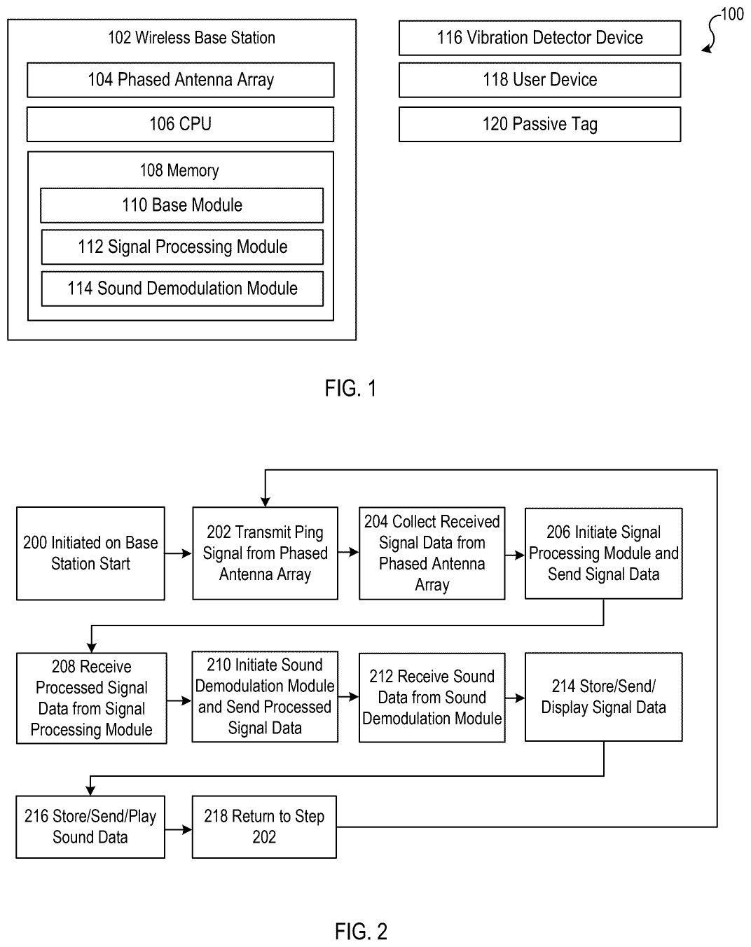

FIG. 1 is a schematic illustration of a phased array tracking system 100 (or “system 100”). The system 100 may include a wireless base station 102, which may track the location of one or more signal sources not initially designed to provide a signal related to sound. The wireless base station 102 may include a phased antenna array 104 comprised of multiple individual antennas, each capable of transmitting and/or receiving electromagnetic signals. The wireless base station 102 receives signals from one or more sources using the phased antenna array 104. It triangulates the location of the source using an angle of arrival (AoA) calculation based on the difference in phase and time of the received signals. The wireless base station 102 may have active and passive functionality, which may be separate modes or both active and passive modes may function simultaneously. Passive functionality may refer to only receiving signals from sources, whereas active functionality may refer to transmitting to a device in order to elicit a response. In other words, the system may operate in an active and/or a passive mode, such that, in the passive mode, radio waves that naturally occur without prompting or responding emanate from the signal source (tracked device), and, in the active mode, the phased antenna array is configured to transmit radio waves that are reflected or retransmitted by the signal source (tracked device) to create a larger sample of data for sound demodulation. The wireless base station 102 may also be a type of wireless base station that allows for a Bluetooth, cellular, or other type of signal frequency connection or broadcast. In one embodiment, the wireless base station 102 may be for military-grade synthetic aperture radar signals. Multiple wireless base stations 102 may be utilized to cover a larger area than the range of a signal wireless base station 102. If a signal source is within range of multiple wireless base stations 102, then the wireless base stations 102 may share signal data to further enhance the signal clarity/accuracy.

The system 100 may further include a phased antenna array 104, which may be an array of antennas that receive and/or transmit at different phases. This phased array 104 may include any combination of receiver antennas, transmitter antennas, and antennas capable of both receiving and transmitting signals, thereby providing versatile communication capabilities. The phased antenna array 104 may include at least one antenna capable of transmission for the active functions of the wireless base station 102, such as beamforming, signal amplification, and directed communication. The phased antenna array 104 may also include at least two antennas capable of receiving for the triangulation functions of the wireless base station 102. These receiving antennas facilitate precise location determination of signal sources through techniques such as angle of arrival (AoA) estimation. The antennas may be arranged in a specific geometric configuration, such as linear, circular, or planar arrays, and electronically connected such that their individual signal phases and amplitudes can be controlled. This electronic control enables the phased array to dynamically steer the beam direction, enhance signal strength, and reduce interference from unwanted sources. The phased antenna array 104 may incorporate advanced signal processing algorithms to optimize its performance. These algorithms may include adaptive beamforming, which adjusts the phase and amplitude of each antenna element to maximize signal reception from desired directions while minimizing noise and interference. The phased antenna array 104 may also support multiple-input multiple-output (MIMO) technology, allowing simultaneous transmission and reception of multiple data streams, thereby increasing the overall data throughput and reliability of the system 100.

The phased antenna array 104 may be integrated with a control unit that monitors and adjusts the operational parameters of each antenna element in real-time. This control unit may utilize feedback mechanisms to dynamically adapt to changing environmental conditions and signal propagation characteristics, ensuring optimal performance under various scenarios. The integration of these features within the phased antenna array 104 enhances the system's capability to provide robust and efficient communication and precise triangulation of signal sources. The phased antenna array 104 may include a low noise amplifier (LNA) to amplify weak incoming signals from multiple antennas while minimizing noise. The LNA may include a number of channels which each correspond to a specific antenna in the phased array, enhancing sensitivity and accuracy. The phased antenna array 104 may be made from advanced materials, such as graphene or metamaterials so as to deliver the increased sensitivity needed for certain applications. The phased antenna array 104 may receive multiple signal types including Wi-Fi, cellular, Bluetooth, radio, near-field communication (NFC), Radio Frequency Identification (RFID) signals, or any other electromagnetic signals.

The system 100 may further include a computer processing unit (CPU) 106, which may be configured to decode and execute any instructions received from one or more other electronic devices or server(s). The CPU 106 may include one or more general-purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor). The CPU 106 may be configured to execute one or more computer-readable program instructions, such as program instructions, to carry out any of the functions described in this description. The CPU 106 may be a GPU such as those produced by Nvidia®.

The system 100 may further include memory 108, which may include but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or another type of media/machine-readable medium suitable for storing electronic instructions. The memory may include modules implemented as a program.

The system 100 may further include a base module 110, which may continuously collect data from the phased antenna array 104. The base module 110 may initiate the signal processing module 112 to process the received signals. After signal processing, the base module 110 may initiate the sound demodulation module 114 to demodulate the noise in the signal caused by sound waves near the antenna. This noise may then be converted back into sound.

The system 100 may further include a signal processing module 112, which may process the signals received by the phased antenna array 104 in order to locate the source of the signal in three-dimensional space. The signal processing module 112 may utilize sophisticated computational techniques such as Kalman filters and joint probabilistic data association to accurately estimate device locations and track their movements while maintaining synchronization among multiple antennas for precise triangulation. The signal processing module 112 may utilize a subnanosecond clock and a high-speed power meter for detecting the small differences in time between receiving a signal at two or more receiver antennas.

The system 100 may further include a sound demodulation module 114, which may demodulate the signals corresponding to relative movement between the phased array antenna 104 and the signal source (based on sound waves impinging on the signal source) in order to extract sound information. Demodulation techniques are used to extract the original sound vibrations from the modulated electromagnetic signal. Several demodulation methods can be applied, depending on the nature of the modulation and the characteristics of the received signal, such as Fourier Analysis, Interferometry, Phase-Locked Loop, etc. The demodulated signal is used to reconstruct the sound waves, which can then be played back or analyzed.

The system 100 may further include a vibration detector device 116, which may be a device that transmits electromagnetic signals and is designed to be extremely sensitive to vibrations, such as those caused by sound waves. The vibration detector device 116 may utilize the piezoelectric effect or MEMS technology to detect minute vibrations caused by voice. The vibration detector device 116 may be most sensitive to the frequency range of human speech (approximately 300 Hz to 3400 Hz).

The system 100 may further include a user device 118, such as a laptop, smartphone, tablet, computer, smart speaker, or any other device capable of transmitting electromagnetic signals.

The system 100 may further include a passive tag 120, which may be a passive device that modulates an active signal from the phased antenna array 104 and is highly sensitive to vibrations from sound waves. For example, passive RFID tags can detect minute vibrations caused by voice. However, any transmitting device can send data to the wireless base station 102 for sound demodulation, and not simply a passive tag 120. Examples of other transmitting devices include, without limitation, phones, laptops, wireless routers, vehicles, smart watches, and wireless head phones. Accordingly, the system should not be construed as being limited to RFID tags.

FIG. 2 illustrates an example operation of the base module 110. The base module 110 may be initiated at step 200 when the wireless base station 102 is powered on and/or activated.

The base module 110 may transmit at step 202 a signal from the phased antenna array 104 in order to ping any passive tags 120 or other passive devices. Passive devices, such as the passive tags 120, do not constantly transmit signals, and so must first receive a signal from the phased antenna array 104 in order to be detected. Note that the reflection of these transmitted signals can also be detected by the phased antenna array 104, which may provide additional signal data from any reflective material, including the antennas of actively transmitting devices. This may be useful when certain active devices, such as cell phones, are transmitting periodically and not constantly. In a scenario with multiple signal sources, the reflection of each signal off each other signal source could also be detected by the phased antenna array, providing an abundance of signal data. For example, the phased antenna array 104 may detect the signal from a smartphone, the signal from the wireless base station 102 reflected off the same smartphone, and a signal from a nearby computer, also reflected off the same smartphone.

The base module 110 may collect at step 204 received signal data from the phased antenna array 104. Signal data may be data on signals received from one or more sources, such as a vibration detector device 116, user device 118, or passive tag 120. Signal data may include the waveform of the signal, the time received, the intensity of the signal, the phase of the signal, or any other property of the signal. Each antenna of the phased antenna array 104 may provide unique signal data.

The base module 110 may initiate at step 206 the signal processing module 112 and send in the signal data. The signal processing module 112 may process the signals received by the phased antenna array 104 in order to locate the source of the signal in three-dimensional space. Achieving centimeter-level accuracy in 3D mapping is useful for applications that require precise positioning and spatial awareness. The system 100 is designed to provide this high level of precision, ensuring that positioning can be accurately determined within centimeter-level tolerances, or better, in 3D space. To enhance the capabilities of 3D mapping, the data obtained from the phased antenna array 104 can be integrated with various other 3D mapping technologies. For instance, synthetic aperture radar (SAR) can be utilized to offer additional spatial data, leveraging its ability to produce high-resolution images and detect changes over time. Incorporating camera-based systems can provide visual context and details that may not be captured by the phased antenna array alone. Ultrasound technology can also be employed, especially in environments where optical or radar-based systems might face challenges, such as underwater or in densely cluttered areas. Additionally, LIDAR technology can be integrated to measure distances by illuminating targets with laser light and measuring the reflection with a sensor, which is useful in applications like autonomous vehicles and topographic mapping. Combining these technologies allows for a more comprehensive 3D mapping process, enhancing accuracy and applicability across various fields. For example, in urban planning, combining phased array data with LIDAR can create detailed city models. In agriculture, integrating data from SAR and drones can help in precise crop monitoring and land use planning. In search and rescue operations, combining ultrasound with phased array data can assist in locating individuals in challenging environments. This approach ensures that the 3D mapping solution is effective in a wide range of scenarios, meeting the diverse needs of different industries and applications.

The signal processing module 112 may utilize sophisticated computational techniques such as Kalman filters and joint probabilistic data association (JPDA) to accurately estimate device locations and track their movements while maintaining synchronization among multiple antennas for precise triangulation. The signal processing module 112 may utilize a subnanosecond clock and a high-speed power meter for detecting the small differences in time between receiving a signal at two or more receiver antennas.

The base module 110 may receive at step 208 processed signal data from the signal processing module 112. The signal data may include tracking data. This tracking data may include the calculated location of each signal source based on received signals. The data may also include metadata such as confidence level and margin of error. For example, the tracking data may include that a user's laptop is at the coordinates (1348 cm, 804 cm, −52 cm) and a passive tag 120 is at the coordinates (1145 m, 210 cm, −30 cm) where the origin (0,0,0) is the location of the wireless base station 102. The signal may also include component data. This component data may include the identified components of the signal. For example, the signal from a user's laptop may include a carrier frequency at 5 GHz and a quadrature amplitude modulation data component, while the signal from a passive tag 120 may include a carrier frequency of 13.56 MHz and a phase-jitter modulation data component.

The base module 110 may initiate at step 210 the sound demodulation module 114 and send in the processed signal data. The sound demodulation module 114 may demodulate the signals received by the phased antenna array 104 in order to extract sound information. Using the component data, the identified components of the signal can be decoupled from the sound frequencies.

The base module 110 may receive at step 212 sound data from the sound demodulation module 114. Sound data may refer to the sound signal and/or sounds extracted from the received signals. For example, sound data may be the sound waves of the ambient sounds near a vibration detection device 116 or the sounds of a phone conversation that a person made using their smartphone.

The base module 110 may store, send, and/or display at step 214 the signal data. The signal data may be stored locally in memory 108. The signal data may be sent to another device such as a user device 118. The signal data may be displayed directly on the wireless base station 102 if a display is available.

The base module 110 may store, send, and/or play at step 216 the sound data. The sound data may be stored locally in memory 108. The sound data may be sent to another device such as a user device 118. The sound data may be displayed and played on the wireless base station 102 if a speaker is available.

The base module 110 may return at step 218 to step 202. The base module 110 may continuously loop as long as the wireless base station 102 is powered and/or active. In some loops, steps may be skipped to save power. For example, the ping signal may not be transmitted in each loop, but instead once every minute.

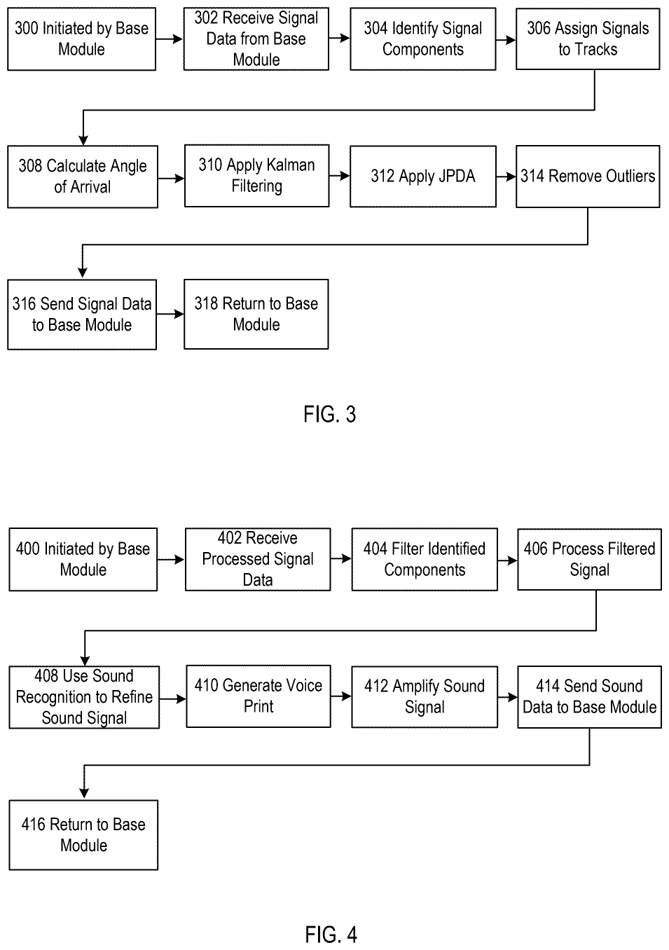

FIG. 3 illustrates an example operation of the signal processing module 112. The signal processing module 112 may be initiated at step 300 by the base module 110. The signal processing module 112 may receive at step 302 signal data from the base module 110.

The signal processing module 112 may identify at step 304 the components of the received signals. Identifying the components of a signal, such as a Wi-Fi signal, may involve various techniques and tools. The signal processing module 112 may perform a frequency domain analysis using a Fast Fourier Transform (FFT). This converts the time-domain signal into its frequency components, allowing it to identify the carrier frequencies and any subcarriers. Tools like spectrum analyzers or SDR software can facilitate this process. The signal processing module 112 may determine the modulation scheme used. Wi-Fi signals typically use Orthogonal Frequency Division Multiplexing (OFDM). Analyzing the signal's modulation involves examining the changes in amplitude, frequency, or phase that encode the data. This can be done using constellation diagrams and demodulation algorithms. The signal processing module 112 may decode the higher-level protocol information. Wi-Fi signals conform to standards such as IEEE 802.11. Protocol analyzers or Wi-Fi sniffers can be used to interpret the protocol layers, extracting information such as MAC addresses, frame types, and payload data. Cellular signals conform to standards such as LTE, GSM, and 5G. Protocol analyzers or cellular sniffers can be used to interpret the protocol layers, extracting information such as IMSI (International Mobile Subscriber Identity), cell tower identifiers, and data payload. Bluetooth signals typically use Gaussian Frequency Shift Keying (GFSK) and other modulation schemes like Phase Shift Keying (PSK) for enhanced data rates. Bluetooth signals conform to standards such as Bluetooth Core Specification. Protocol analyzers or Bluetooth sniffers can be used to interpret the protocol layers, extracting information such as device addresses, service records, and data payload. Note that decryption of the data is not required for the data components to be identified. The signal processing module 112 may assign at step 306 the signals to tracks, associating new signals with existing tracks or creating new tracks. This involves analyzing the signal data and determining which signals correspond to which tracked signal source. The signal processing module 112 may use criteria such as signal strength, frequency, phase, identifying data, and timing information to match signals to known tracks. If a signal does not match any existing track, a new track is created. This step is useful for organizing the signal data into coherent tracks that can be further analyzed and monitored.

The signal processing module 112 may calculate at step 308 the angle of arrival (AoA) for each signal using phase and time delay data. This involves determining the direction from which each signal is arriving relative to the phased array. The signal processing module 112 may use the phase differences and time delays between the signals received at different antennas to calculate the AoA. This step is useful for understanding the spatial orientation of the signal sources and is used in some embodiments in triangulating their positions. For example, the signal data indicates that a 2.4 GHz signal was received at antennas 1 and 2 of the phased antenna array 104. The signal was received 3 nanoseconds later at antenna 2, and the phase was shifted by 1 radian. Assume the antennas are 10 cm apart. The path difference (Δd) can be calculated using the time delay using the equation Δd=c×Δt, where c is the speed of light in air. For a Δt value of 3 nanoseconds, the path difference is 9 cm. The sine function of the AoA is equal to the path difference over the antenna separation, sin (AoA)=Δd/d. Evaluating this for a path distance of 9 cm gives an AoA of approximately 1.12 radians. For another example, the signal data indicates that a 2.4 GHz signal was received by antennas 3 and 4 of the phased antenna array 104. The signal was received 2 nanoseconds later at antenna 4, and the phase was shifted by 1 radian. Assume the antennas are 10 cm apart. The phase difference (Δφ) can be converted to path difference (Δd) using Δd=(Δφ·λ)/2π. Where λ is the wavelength. Wavelength can be calculated from (Δ)=c/f, where c is the speed of light and f is frequency. Since the frequency is 2.4 GHz, the wavelength is 12.5 cm. Plugging in the wavelength and phase difference gives a path difference of about 2 cm. The sine function of the AoA is equal to the path difference over the antenna separation, sin (AoA)=Δd/d. Evaluating this for a path distance of 2 cm gives an AoA of approximately 0.20 radians. Using multiple methods of calculating the AoA allows the signal processing module 112 to check if all methods agree, and if not, to pick the most reliable method or approximate a value based on the answers of each method.

In addition, or alternatively, the signal processing module 112 may use the received signal strength to perform trilateration. Trilateration is an alternative method of determining the position of a signal source by calculating the distances between the source and multiple receiving antennas. Distance estimation can be performed using the AoA data, where known positions of the antennas and the angles of the incoming signal are used to infer the distance. However, a more direct and sometimes more precise method may involve deriving the distance from the difference in signal strength received at two or more antennas. The principle behind this method is based on the inverse relationship between signal strength and distance. As the distance from the signal source to the antenna increases, the signal strength decreases, typically following an inverse-square law or a similar attenuation model depending on the environment. In scenarios where trilateration is implemented, the signal processing module 112 may require at least three antennas to determine the exact location of the signal source. The use of three antennas allows the formation of three independent distance equations, which, when solved simultaneously, may provide a unique intersection point corresponding to the location of the signal source. The received signal strength at each antenna may provide the basis for calculating the respective distances. For example, if the signal at one antenna is stronger by a known percentage compared to another, the ratio of these signal strengths can be used to infer the ratio of the distances. By combining this information with the known physical separation between the antennas, the system can establish a set of nonlinear equations representing the distances from the source to each antenna. The solution involves finding the point where the calculated distances (based on signal strength differences) intersect, which represents the most likely location of the signal source relative to the antenna array. Furthermore, the accuracy of trilateration can be enhanced by incorporating additional antennas, which provide more distance measurements and, consequently, reduce the uncertainty in the position estimate. The use of more antennas allows for the implementation of overdetermined systems, where the additional data can be used to minimize errors and improve the robustness of the location estimation process. Trilateration is particularly advantageous in environments where the AoA measurement might be challenging due to multipath propagation or other interference effects that distort the apparent AoA. Trialateration may be used in place of or in conjunction with triangulation.

The signal processing module 112 may apply at step 310 Kalman filtering to predict and update the state of tracked objects. The Kalman filter uses a series of measurements observed over time, containing statistical noise and other inaccuracies, to produce estimates of unknown variables. It operates in a two-step process: prediction and update. During the prediction step, the Kalman filter uses the current state estimate to predict the state at the next time step. During the update step, the filter incorporates new measurements to correct the state estimate. This process helps to smooth out the tracking data and provides more accurate estimates of the positions and velocities of tracked objects.

The signal processing module 112 may apply at step 312 Joint Probabilistic Data Association (JPDA) to associate measurements with tracks probabilistically. JPDA is used in scenarios where there are multiple potential targets and measurements, and it is not clear which measurement corresponds to which target. The signal processing module 112 may calculate the probabilities of each measurement being associated with each track and update the tracks based on these probabilities. This method helps to resolve ambiguities and improves the accuracy of tracking in complex environments with multiple signal sources.

To address complex environments, a Multiple Signal Classification (MUSIC) algorithm can be used. In signal processing problems, the objective is to estimate from past measurements or expectations of measurements from a set of constant values upon which the received signals depend.

In an embodiment, in order to solve the multipath problem for high accuracy tracking, the MUSIC algorithm is used to estimate the AoA of one or more signals arriving at the antenna array. The MUSIC algorithm uses an eigenspace method to determine and express the phase shift between the antennas as a complex exponential.

$$Φ ( θ ) = {e}^{- j 2 π sin ( d ) / λ}$$

$$\vec{a ( θ )} = [ \begin{matrix}1 & Φ ( θ ) & {Φ ( θ )}^{2} & \begin{matrix}… & {Φ ( θ )}^{M - 1}\end{matrix} ]\end{matrix}$$

As shown above in the equation, the phase shift of an incoming signal F(q) is determined as a function of the distance between two antennas, d, and the wavelength of the signal 1. The vector a(0) represents an overall direction in which the antenna array will form a beam, wherein each element of the vector represents an individual multipath signal. For M number of antennas in the array, the vector a(q) includes M−1 processed signals. Due to the delay in transmission across the array, the vector a(q) may be used by the tracking system to steer a signal in the direction of the vector or to indicate that an incoming signal is received from the direction of the vector. The correlation matrix of an incoming signal x is given as Rxx, where eigenvectors of Rxx corresponding to its smallest eigenvalues are orthogonal to the steering vectors. Mathematically, this is done by evaluating the MUSIC spectrum according to the equation:

$${P}_{MU} ( θ ) = \frac{1}{{\vec{a} ( θ )}^{H} {E}_{N} {E}_{N}^{H} \vec{a} ( θ )}$$

In the above equation, H denotes the Hermitian self-adjoint matrix as a complex square matrix. EN is a matrix whose columns are the eigenvectors of Rxx corresponding eigenvalues smaller than a threshold value. Systems using the MUSIC algorithm to determine AoA for incoming signals typically need more antennas than propagation paths to resolve the incoming signals correctly. For example, the MUSIC algorithm resolves up to M−1 different signal paths (e.g., in the case of 3 antennas in the array, only 2 multipath signals can be differentiated). In one embodiment, the system overcomes the limitation of resolving M−1 signal paths by implementing multiple antennas, linked but not collocated, such that an interlinked mesh network processes signals received by the antennas as a fleet. Multiple sensors compute signal paths and the interlinked mesh network determines a true origin of the signal based on the computed paths to perform distributed spatial smoothing. Antennas may be selected or spaced for any number of multipath signals. For example, in high-frequency applications, the spacing of antenna elements can be selected based on the wavelength of multipath signals. Additionally, antennas rated for a high number of multipath signal can be larger than antennas rated for a lower number of multipath signals. In one embodiment, the antenna array includes one or more antenna with fewer antenna elements, and the interlinked mesh network is used to collect, process, and resolve data collected by the antenna array.

The signal processing module 112 may remove at step 314 outliers to ensure the accuracy of the tracking data. Outliers are measurements that deviate significantly from the expected values and can distort the tracking results. The signal processing module 112 may use statistical analysis and predefined thresholds to identify and filter out these erroneous data points. By removing outliers, the system 100 improves the reliability and precision of the tracking data, ensuring that accurate and consistent measurements are used in the final tracking calculations.

The signal processing module 112 may send at step 316 the finalized signal data to the base module 110. The signal data may include tracking data. This tracking data may include the calculated location of each signal source based on received signals. The data may also include metadata such as confidence level and margin of error. For example, the tracking data may include that a user's laptop is at the coordinates (1348 cm, 804 cm, −52 cm) and a passive tag 120 is at the coordinates (1145 m, 210 cm, −30 cm) where the origin (0,0,0) is the location of the wireless base station 102. The signal may also include component data. This component data may include the identified components of the signal. For example, the signal from a user's laptop may include a carrier frequency at 2.4 GHz and a quadrature amplitude modulation data component, while the signal from a passive tag 120 may include a carrier frequency of 13.56 MHz and a phase-jitter modulation data component. The signal processing module 112 may return at step 318 to the base module 110.

FIG. 4 illustrates an example operation of the sound demodulation module 114. The sound demodulation module 114 may be initiated at step 400 by the base module 110. The sound demodulation module 114 may receive at step 402 the processed signal data from the base module 110.

The sound demodulation module 114 may filter at step 404 the identified components of the signal. For example, a bandpass filter may be used to filter out the 5 GHz carrier signal from a Wi-Fi signal. Once the identified components of the signal are removed, the remaining signal contains the sound signal and any other noise common to electromagnetic signals. The sound signal modulates the original electromagnetic signal via the Doppler effect. The movement of the antenna of the signal source due to vibration from sound causes small changes in the frequency and/or amplitude of the signal. By removing the identified components of the signal, the sound at the source of the signal can be reconstructed.

The sound demodulation module 114 may process at step 406 the filtered signal to isolate the sound signal from any other noise in the original signal. This may involve methods such as independent component analysis, fast Fourier transform, low-pass filtering, digital signal processing, or any other method of signal processing which would serve to isolate the sound signal or reduce the noise in the filtered signal.

The sound demodulation module 114 may use at step 408 sound recognition algorithms to identify sounds in the signal. These algorithms may use AI or machine learning to identify common sounds. For example, voice recognition software may be used to detect spoken words in the sound signal. This step allows the sound detection module 114 to further isolate the sound signal from other noise in the filtered signal. This step may also be useful for automatically detecting words or phrases of interest. A large language model may be utilized to recognize human speech, possibly translate foreign languages detected, and/or recognize patterns of speech for data processing to trigger events such as an alarm. For example, if the words “let's steal” are detected in a store, security can be alerted and dispatched. For another example, if a loud crash occurs in the front window of a store, then glass shattering may be detected, and the system 100 can alert security that glass was broken in the store after hours and there may be an ongoing attempted robbery. The signal data may contain the same conversation which modulated the signal of three different signal sources near the source of the sound. The signals of the three signal sources are received by the wireless base station 102 simultaneously. The sound data extracted from each source may be combined, resulting in a highly accurate demodulation of the entire conversation. Whether there are multiple signal sources or only a single source, generative AI can be utilized to fill in gaps in the conversation, taking into account sentiment and context. This may create multiple different completed conversation possibilities each with an assigned confidence metric. Sound data may be cross referenced with existing sound data sets or libraries, such as music libraries, common sound databases, a database of audio from movies, shows, and other videos, a database of words or phrases, or any other database containing sound data. For example, music recognition software may be used to identify music being played by the signal source or being played nearby. The music may be compared to a database of known songs in order to identify the song being played.

The sound demodulation module 114 may generate at step 410 a voice print from the identified sound signal if the sound contains a voice. Key characteristics of the voice, known as features, are extracted from the sound signal. Common features include Mel-Frequency Cepstral Coefficients (MFCCs), Linear Predictive Coding (LPC) coefficients, and formant frequencies. These features capture the unique spectral properties of the speaker's voice. The extracted features are then used to create a voice print, a unique digital representation of the speaker's voice. This process involves mapping the features into a high-dimensional feature space where the voice print can be uniquely identified. The created voice print may be compared to a database of known voice prints using pattern recognition techniques. Common methods include dynamic time warping (DTW), hidden Markov models (HMM), and Gaussian mixture models (GMM). These models help in matching the input voice print with the stored templates based on the similarity of their feature vectors. An identified voice print can be correlated with a device. This may enable voice detected by the system 100 to trigger an event, such as an advertisement, on the device directly or through a social media platform. Voice print detection may also offer another layer of security and/or authentication. Common voice prints may be stored locally in memory 108, or voice print matching may be done by another computer or network.

The sound demodulation module 114 may amplify at step 412 the isolated sound signal so that it can be played back at an audible intensity. The sound demodulation module 114 may send at step 414 the sound data to the base module 110. Sound data may include the sound signal and any identified sounds, words, phrases, etc. The sound demodulation module 114 may return at step 416 to the base module 110.

Any and all of the above steps may utilize artificial intelligence (AI), such as large language models (LLMs), for processing, interpreting, analyzing, reconstructing, or otherwise manipulating data. LLM may refer to an AI system designed to understand and generate human language. Specifically, an LLM is characterized by its extensive training on vast corpora of text data, utilizing deep learning techniques, particularly neural networks with numerous layers and parameters. These models are adept at tasks involving natural language processing, such as translation, summarization, and text generation, by predicting the likelihood of word sequences based on learned linguistic patterns.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A system comprising:
a phased antenna array configured to receive signals from at least one signal source not initially designed to provide a signal related to sound;
a signal processor configured to locate the at least one signal source using the received signals and detect a movement of the at least one signal source relative to the phased antenna array, wherein the detected movement is at least partially in response to sound waves impinging on the at least one signal source; and
a sound demodulator configured to demodulate a sound signal from the detected movement.

2. The system of claim 1, wherein the at least one signal source includes one or more of a vibration detector, a passive tag, and/or a user device.

3. The system of claim 2, wherein the vibration detector actively transmits the signals to the phased antenna array without being pinged by the phased antenna array.

4. The system of claim 2, wherein the passive tag transmits the signals to the phased antenna array in response to being pinged by the phased antenna array.

5. The system of claim 2, wherein the system operates in an active and/or a passive mode, such that, in the passive mode, radio waves that naturally occur without prompting or responding emanate from the at least one signal source, and, in the active mode, the phased antenna array is configured to transmit radio waves that are reflected or retransmitted by the at least one signal source to create a larger sample of data for sound demodulation.

6. The system of claim 1, wherein the signal processor is configured to locate the at least one signal source using one or more of Kalman filtering, a joint probabilistic data association (JPDA) operation, and/or a Multiple Signal Classification (MUSIC) algorithm.

7. The system of claim 1, wherein the signal processor is configured to triangulate a location of the at least one signal source using an angle of arrival (AoA) calculation based on a difference in phase and time of the received signals arriving at the phased antenna array.

8. The system of claim 1, wherein the signal processor is configured to determine a location of the at least one signal source using trilateration.

9. The system of claim 1, wherein the signal processor is further configured to identify signal components of the signals from the at least one signal source.

10. The system of claim 1, wherein the sound demodulator is configured to filter identified components of the received signals to produce a filtered signal.

11. The system of claim 10, wherein the sound demodulator is configured to process the filtered signal to isolate the sound signal from noise in the filtered signal.

12. The system of claim 11, wherein the sound demodulator is configured to process the filtered signal by one or more of independent component analysis, fast Fourier transform, low-pass filtering, and/or digital signal processing.

13. The system of claim 11, wherein the sound demodulator is configured to apply a sound recognition algorithm to identify the sound signal in the received signals.

14. The system of claim 13, wherein the sound recognition algorithm uses machine learning to identify a particular sound in the sound signal.

15. The system of claim 13, wherein the sound demodulator is configured to generate a voice print from the sound signal if the sound signal contains a voice.

16. The system of claim 15, wherein the voice print is identified based on features including Mel-Frequency Cepstral Coefficients (MFCCs), Linear Predictive Coding (LPC) coefficients, and/or formant frequencies.

17. The system of claim 13, wherein the sound demodulator is further configured to amplify the sound signal to an audible intensity.

18. The system of claim 17, further comprising a sound output device to play the amplified sound signal.

19. A method comprising:
receiving, via a phased antenna array, signals from at least one signal source not initially designed to provide a signal related to sound;
locating, via signal processor, the at least one signal source using the received signals;
detecting, via the signal processor, a movement of the at least one signal source relative to the phased antenna array, wherein the detected movement is at least partially in response to sound waves impinging on the at least one signal source; and
demodulating a sound signal from the detected movement.

20. The method of claim 19, further comprising playing the sound signal on an output device.
